(19) United States
(12) Patent Application Publication
(10) Pub. No.: US 2026/0188108 A1
(43) Pub. Date: Jul. 2, 2026

(54) IMPROVED HANDSHAKE PROCESSES FOR V2X COMMUNICATION

(71) Applicant: TOYOTA MOTOR ENGINEERING & MANUFACTURING NORTH AMERICA, INC., Plano, TX (US)

(72) Inventors: CHUNGHAN LEE, Mountain View, CA (US); Seyhan Ucar, Mountain View, CA (US); Onur Altintas, Mountain View, CA (US); Kentaro Oguchi, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/005,444

(22) Filed: Dec. 30, 2024

(51) Int. Cl. G08G 1/01

(52) U.S. Cl. CPC G08G 1/0112; G08G 1/0125; G08G 1/0141

(57) ABSTRACT

In some implementations, systems and methods may include a memory storing machine-readable instructions that, when executed by one or more processors, may cause a vehicle to: determine a number of handshake packets to send to a second vehicle based on a positional relationship between the vehicle and the second vehicle; and send the determined number of handshake packets to the second vehicle. In further implementations, systems and methods may include a memory storing machine-readable instructions that, when executed by one or more processors, cause a vehicle to: proactively send a cryptographic cookie to a second vehicle, which may include sending the cryptographic cookie to the second vehicle without having previously received a request for the cryptographic cookie from the second vehicle; and completing a handshake process with the second vehicle after proactively sending the cryptographic cookie to the second vehicle.

### TECHNICAL FIELD

The present disclosure relates generally to automotive systems and technologies. More particularly, some embodiments relate to improved handshake processes for vehicle-to-everything (V2X) communication.

### DESCRIPTION OF RELATED ART

A handshake process can be used to establish a secure/reliable wireless connection between two communicating devices (sometimes referred to as a server device and a client device).

For example, the Transmission Control Protocol (TCP) 3-Way handshake is a standard handshake process for TCP. The TCP 3-Way handshake generally involves a first device (sometimes referred to as a client device) sending a Synchronize (SYN) packet with a request for a cryptographic cookie to a second device (sometimes referred to as a server device). In response to receiving the SYN packet, the second/server device generates the cryptographic cookie—and sends a Synchronize-Acknowledge (SYN-ACK) packet that includes the generated cryptographic cookie to the first/client device. In response to receiving the SYN-ACK packet, the first/client device sends an Acknowledge (ACK) packet to the second/server device. The TCP 3-Way handshake is complete when the second/server device receives the ACK packet. Namely, the first/client device can send the cryptographic cookie with non-handshake-related data (e.g., data related to a software application running on the client and server devices) to the second/server device in future communications over a wireless connection. The second/server device can relatedly validate future data transmissions from the first/client device using the cryptographic cookie.

Conventionally under the TCP 3-Way handshake, the first/client device cannot begin transmitting non-handshake-related data to the second/server device until the first/client device sends the ACK packet. Relatedly, the second/server device cannot begin transmitting non-handshake-related data to the first/client device until the second/server device receives the ACK packet. Moreover, the above-described TCP 3-Way handshake is conventionally performed for each, new TCP connection between the first/client and second/server devices.

Another handshake process for TCP is the TCP Fast Open handshake. The TCP Fast Open handshake involves an expedited handshake process for subsequent TCP connections between a first/client device and a second/server device (i.e., TCP connections after a first/initial TCP connection). Namely, a first/initial TCP connection between the first/client device and the second/server device may be established using the standard TCP 3-Way handshake described above. However, when the first/client device wants to send non-handshake-related data to the second/server device over a second TCP connection (e.g., at a later time after the first TCP connection has lapsed), the first/client device can send the second/server device a SYN packet that includes: (1) the generated/exchanged cryptographic cookie from the first TCP connection; and (2) the non-handshake-related data that the first/client device wants to exchange with the second/server device. In response to receiving the SYN packet, the second/server device can send a SYN-ACK packet to the first/client device. Upon receiving the SYN-ACK packet, the first/client can then transmit an ACK packet to the second/server device.

Distinct from the standard TCP 3-Way handshake described above, under the TCP Fast Open handshake the second/server device can send non-handshake-related data over the second TCP connection before receiving an ACK packet from the first/client device. Likewise (and also distinct from the standard TCP 3-Way handshake described above), the first/client device can send non-handshake-related data with the initial SYN packet over the second TCP connection. In these ways, the TCP Fast Open handshake can expedite the handshake process for subsequent TCP connections (i.e., TCP connections after a first/initial TCP connection) between the first/client and second/server devices.

### BRIEF SUMMARY OF THE DISCLOSURE

According to various embodiments of the presently disclosed technology, vehicles and computer-implemented methods are provided for vehicle communications.

Some implementations discussed herein relate to techniques involving vehicles equipped with one or more processors and memory storing machine-readable instructions. These instructions, when executed by the one or more processors, enable the vehicle to perform tasks such as determining the number of handshake packets to send to a second vehicle based on the positional relationship of the vehicles, and subsequently sending the determined number of handshake packets. The handshake packets may include Synchronize (SYN) packets, and the vehicle's memory may further store instructions that facilitate receiving a Synchronize-Acknowledgement (SYN-ACK) packet from the second vehicle, acknowledging receipt of the handshake packets. The vehicle may then send an Acknowledge (ACK) packet to confirm receipt of the SYN-ACK packet. The positional relationship between vehicles can be determined by assessing factors such as the distance between them, potential hindrances to line of sight, and whether either vehicle is moving above a threshold speed.

According to various aspects, a vehicle can receive and cache a cryptographic cookie from the second vehicle without having previously requested it. This cryptographic cookie may contain information such as the geographic location and speed of the second vehicle, an estimated distance between the vehicles, and whether the line of sight is obstructed. It may also include data about software applications used by the second vehicle and its type. If the second vehicle acts as a vehicular micro-cloud (VMC) leader, the cookie might include information related to VMC roles. The vehicle can use this information to exchange data with the second vehicle, relevant to the software applications or tasks associated with the VMC.

Some implementations may involve proactively sending a cryptographic cookie to a second vehicle without a prior request, completing a handshake process after the cookie is sent. In response to receiving a SYN packet with the cryptographic cookie and initial data from the second vehicle, the vehicle sends a SYN-ACK packet to acknowledge receipt and may send subsequent data before receiving an ACK packet from the second vehicle. The vehicle may generate cryptographic cookies that include details such as its geographic location, speed, and potential obstructions to line of sight, along with information about its software applications and vehicle type.

Proactive communication may involve sending the cryptographic cookie via a beacon or through cloud-based and infrastructure-based communication resources. The vehicle may determine its proximity to a traffic waiting zone and send the cookie if within a threshold distance, facilitating smoother interactions before reaching the zone. The traffic waiting zone is defined as a segment of the road near a traffic signal. These methods can be implemented using hardware, processes, or computer tangible media, allowing for secure and efficient communication between vehicles.

According to various embodiments, a vehicle may include: one or more processors; and memory storing machine-readable instructions that, when executed by the one or more processors, cause the vehicle to: determine a number of handshake packets to send to a second vehicle based on a positional relationship between the vehicle and the second vehicle; and send the determined number of handshake packets to the second vehicle.

In various embodiments, the handshake packets may include Synchronize (SYN) packets and further where the memory stores further instructions, that when executed by the one or more processors, cause the vehicle to: receive, from the second vehicle, a Synchronize-Acknowledgement (SYN-ACK) packet acknowledging the second vehicle's receipt of at least one of the determined number of handshake packets; and send an Acknowledge (ACK) packet to the second vehicle acknowledging the vehicle's receipt of the SYN-ACK packet.

In further embodiments, the memory stores further instructions, that when executed by the one or more processors, cause the vehicle to determine the positional relationship between the vehicle and the second vehicle by determining at least one of: a distance between the vehicle and the second vehicle; whether a line of sight between the vehicle and the second vehicle is hindered; and whether at least one of the vehicle and the second vehicle are moving above a threshold speed.

The memory may store further instructions, that when executed by the one or more processors, cause the vehicle to receive and cache a cryptographic cookie sent by the second vehicle without having previously sent a request to the second vehicle for the cryptographic cookie.

The memory may store further instructions, that when executed by the one or more processors, cause the vehicle to determine the positional relationship between the vehicle and the second vehicle using information contained in the cryptographic cookie.

The information contained in the cryptographic cookie may include at least one of: a geographic location of the second vehicle; a speed of the second vehicle; an estimated distance between the vehicle and the second vehicle; and whether a line of sight between the vehicle and the second vehicle is hindered.

The information contained in the cryptographic cookie further may include at least one of: information indicating one or more software applications used by the second vehicle; and a vehicle type for the second vehicle.

In some applications, data to be exchanged with the second vehicle may be related to the one or more software applications used by the second vehicle.

The second vehicle may be a vehicular micro-cloud (VMC) leader and the information contained in the cryptographic cookie further may include information related to VMC roles.

Data to be exchanged with the second vehicle may be related to a task of the VMC

The memory may store further instructions, that when executed by the one or more processors, cause the vehicle to receive and cache a cryptographic cookie from the second vehicle without previously sending a request for the cryptographic cookie to the second vehicle.

A vehicle may include: one or more processors; and memory storing machine-readable instructions that, when executed by the one or more processors, cause the vehicle to: proactively send a cryptographic cookie to a second vehicle, where proactively sending the cryptographic cookie to the second vehicle may include sending the cryptographic cookie to the second vehicle without having previously received a request for the cryptographic cookie from the second vehicle; and completing a handshake process with the second vehicle after proactively sending the cryptographic cookie to the second vehicle.

The memory may store further instructions, that when executed by the one or more processors, cause the vehicle to, in response to receiving, from the second vehicle, a Synchronize (SYN) packet may include the cryptographic cookie and first data: send a Synchronize-Acknowledge (SYN-ACK) packet to the second vehicle acknowledging receipt of the SYN packet, and before receiving an Acknowledge (ACK) packet from the second vehicle acknowledging the second vehicle's receipt of the SYN-ACK packet, send second data to the second vehicle.

The memory may store further instructions, that when executed by the one or more processors, cause the vehicle to send to the second vehicle responses to data received from the second vehicle prior to completing the handshake process.

The memory may store further instructions, that when executed by the one or more processors, cause the vehicle to generate the cryptographic cookie to include at least one of: a geographic location of the vehicle; a speed of the vehicle; an estimated distance between the vehicle and the second vehicle; and information indicating whether a line of sight between the vehicle and the second vehicle is hindered.

Generating the cryptographic cookie may include generating the cryptographic cookie to further include at least one of: information indicating one or more software applications used by the vehicle; and a vehicle type for the vehicle.

The first data and the second data may be related to the one or more software applications used by the vehicle. The first data and the second data are related to a task of the VMC.

The vehicle may be a vehicular micro-cloud (VMC) leader and generating the cryptographic cookie may include generating the cryptographic cookie to further include information related to VMC roles.

Proactively sending the cryptographic cookie to the second vehicle may include at least one of: sending the cryptographic cookie to the second vehicle via a beacon when the second vehicle is within wireless coverage range of the vehicle; and sending the cryptographic cookie to at least one of a cloud-based communication resource and an infrastructure-based communication resource, where the at least one of the cloud-based communication resource and the infrastructure-based communication resource transmits the cryptographic cookie to the second vehicle.

The memory may store further instructions, that when executed by the one or more processors, cause the vehicle to: determine the vehicle and the second vehicle are within a threshold proximity to a traffic waiting zone; where proactively sending the cryptographic cookie to the second vehicle may include: in response to determining the vehicle and the second vehicle are within the threshold proximity to the traffic waiting zone, proactively sending the cryptographic cookie to the second vehicle before the vehicle and the second vehicle reach the traffic waiting zone.

The traffic waiting zone may include a region of a road segment traversed by the vehicle and the second vehicle, bounded at one end by a traffic signal, and extending away from the traffic signal towards the region of the road segment by a determined distance.

Systems and methods may include: receiving and caching, by a first vehicle, a cryptographic cookie sent by a second vehicle; determining, by the first vehicle, a number of Synchronize (SYN) packets to send to the second vehicle based on a positional relationship between the first vehicle and the second vehicle; and sending, by the first vehicle, the determined number of SYN packets to the second vehicle, where a respective SYN packet may include the cryptographic cookie and data to be exchanged with the second vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict example embodiments.

FIGS. 1A-1B illustrate an example road segment over which embodiments of the presently disclosed technology may be implemented.

FIG. 2 illustrates an example vehicle, in accordance with various embodiments of the presently disclosed technology.

FIG. 3 illustrates an example implementation of a vehicle-to-everything (V2X) handshake system, in accordance with various embodiments of the presently disclosed technology.

FIG. 4 illustrates an example handshake process for V2X communication, in accordance with various embodiments of the presently disclosed technology.

FIG. 5 illustrates another example handshake process for V2X communication that may be performed by a vehicle, in accordance with various embodiments of the presently disclosed technology.

FIG. 6 illustrates another example handshake process for V2X communication that may be performed by a vehicle, in accordance with various embodiments of the presently disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

Vehicle-to-everything (V2X) networks enable vehicles to communicate wirelessly via one or more communication protocols (e.g., TCP, TLS over TCP, HTTPs over TCP, GRPC over TCP, etc.). V2X networks can include vehicle-to-vehicle (V2V) networks, vehicle-to-infrastructure (V2I) networks, vehicle-to-network (V2N) networks, or any combination thereof.

As an example of V2X communication, two vehicles may establish a wireless connection (e.g., a TCP connection) to transmit data. In some cases, the two vehicles can use a handshake process (e.g., the TCP 3-Way handshake or the TCP Fast Open handshake) to ensure the wireless connection is secure and reliable prior to transmitting non-handshake-related data.

In general, performance/reliability for V2X communication decreases (e.g., with longer and more variable packet round-trip times (RTTs), higher incidence of packet loss, etc.) with increasing distance between two vehicles. Physical obstructions between the two vehicles (e.g., intermediate vehicles positioned between the two vehicles, roadside infrastructure positioned between the two vehicles, etc.) and relative movement between the two vehicles (e.g., the two vehicles moving farther apart, or moving with different headings) can also negatively impact performance/reliability for V2X communication.

For the reasons above, traffic waiting zones can provide favorable conditions for V2X network performance/reliability. As used herein, a traffic waiting zone may refer to a region of a road segment where nominal vehicle speed is stopped or is less than 5 MPH. An example of a traffic waiting zone may be a traffic signal waiting zone. For instance, an example traffic signal waiting zone may comprise a region of a road segment bounded at one end by a traffic signal (e.g., a traffic light, stop sign, yield sign, etc.), and extending away from the traffic signal by a determined distance (e.g., 50 feet). Although embodiments of the technology disclosed and claimed herein may be used in applications with any number of traffic waiting zones (e.g., traffic jams, queuing for road obstacles/impediments, construction zones and so on), this specification often describes embodiments in terms of traffic signal waiting zones. This is done for ease of explanation only and not by way of limitation.

As alluded to above, traffic waiting zones can provide favorable conditions for V2X network performance/reliability (e.g., as measured by round trip time (RTT) for exchanged packets, reduced packet loss, etc.). Namely, while waiting (e.g., stopped/stationary) within traffic waiting zones, vehicles are often within close proximity, and not moving relative to each other. Relatedly, it is less likely that a new obstruction will be introduced between two communicating vehicles during data transmission. The heightened V2X network performance/reliability often present at traffic waiting zones can be especially important when a relatively large amount of data needs to be transmitted in a particular order, or via a continuous transmission. Accordingly, a substantial amount of V2X communication may generally occur when vehicles are waiting (e.g., stopped/stationary) within traffic waiting zones.

However, in many situations the “dwell time” (i.e., time spent stationary or below a threshold speed) at traffic waiting zones is shorter than the time required to: (1) complete a conventional handshake process to secure/establish a wireless connection between two vehicles; and (2) transmit a requisite amount of non-handshake-related data via the secured/established wireless connection. Relatedly, in situations where the two vehicles are relatively far apart (e.g., over a threshold distance apart) or have their line of sight to each other obstructed, it becomes increasingly likely that the handshake packets (e.g., SYN, SYN-ACK, or ACK packets) transmitted during the conventional handshake process are not received—which can further delay completion for the conventional handshake process.

Accordingly, in various situations a conventional handshake process may not be fully completed, or a requisite amount of non-handshake-related data may not be fully transmitted, before two vehicles leave a traffic waiting zone. This may delay or otherwise reduce performance for V2X communication between the two vehicles—and consequently delay or otherwise reduce performance for collaborative tasks involving the two vehicles.

Relatedly, proliferation of V2X communication at traffic waiting zones can present challenges as well. For example, when a large number of vehicles are attempting to complete conventional handshake processes while waiting at a traffic light, wireless communication channels in that geographic region can become overloaded. With overloaded wireless communication channels, V2X networks may have reduced performance, and data transmission times can increase.

For the reasons stated above, technical solutions that facilitate faster and more efficient handshake processes for V2X communication (at traffic waiting zones or otherwise) can provide tremendous benefits.

Against this backdrop, systems and methods of the presently disclosed technology provide faster and more efficient handshake processes for V2X communication by: (1) enabling a first vehicle to proactively send a cryptographic cookie to a second vehicle (i.e., without having previously received a request for the cryptographic cookie from the second vehicle); and (2) enabling the second vehicle to tailor a number of Synchronize (SYN) packets simultaneously (or approximately simultaneously) sent to the first vehicle based on a positional relationship between the first vehicle and the second vehicle. Here, a respective SYN packet may be a duplicate of the other SYN packets, and may comprise the cryptographic cookie and non-handshake-related data to be exchanged with the first vehicle.

By enabling the first vehicle to proactively send the cryptographic cookie to the second vehicle, the presently disclosed handshake process can reduce a number of packets/communications required to complete a handshake as compared to conventional handshake processes. For example, unlike the TCP Fast Open handshake, the presently disclosed handshake process may not require a first/initial TCP 3-Way handshake to initially transmit the cryptographic cookie from the first vehicle to the second vehicle. Instead, a single proactive packet/transmission may be used to initially transmit the cryptographic cookie from the first vehicle to the second vehicle.

Moreover, in various implementations, the first vehicle may intelligently determine which vehicles to proactively send the cryptographic cookie(s) to.

For example, the first vehicle may be a leader of a vehicular micro-cloud (VMC) (a VMC may refer to a group of interconnected vehicles that share resources to complete a task). Anticipating future V2X communication with other vehicles of the VMC, the first vehicle may proactively send the cryptographic cookie to the other vehicles of the VMC. Thus, the first vehicle can reduce a number of packets/transmissions required to perform (anticipated) handshake processes within the VMC. In doing so, the first vehicle can increase speed for communication and performance of VMC tasks, conserve bandwidth/network resources, etc.

In certain implementations, the first vehicle can also intelligently determine when to proactively send the cryptographic cookie. In some of such implementations, this may reduce a number of packets/transmissions exchanged at a traffic waiting zone. For example, the first vehicle may determine the first vehicle and the second vehicle are within a threshold proximity of a traffic waiting zone (e.g., within 100 ft). In response to this determination, the first vehicle may proactively send the cryptographic cookie to the second vehicle before the first vehicle and the second vehicle reach the traffic waiting zone—thus further reducing a number of packets/transmissions exchanged within the traffic waiting zone. Relatedly, by waiting to send the cryptographic cookie to the second vehicle until the first and second vehicles are within the threshold (e.g., imminent) proximity of a traffic waiting zone, the first vehicle can reduce a likelihood that the cryptographic cookie is not used by the second vehicle due to lack of V2X communication opportunity. Such lack of V2X communication opportunity may result from the first and second vehicle taking divergent paths, or the first and second vehicles otherwise remaining in an unsuitable positional relationship for extended/lengthy V2X communication.

By enabling the second vehicle to tailor the number of SYN packets simultaneously (or approximately simultaneously) sent to the first vehicle based on the positional relationship between the first vehicle and the second vehicle, the presently disclosed handshake process can increase reliability and speed for V2X handshakes, while limiting excess/duplicative SYN packet transmissions.

Namely (and as alluded to above), performance/reliability for V2X communication can vary based on the positional relationship between the first and second vehicles. For example, performance/reliability for V2X communication generally decreases (e.g., with longer and more variable packet round-trip times (RTTs), higher incidence of packet loss, etc.) with increasing distance between the first and second vehicles. Physical obstructions between the first and second vehicles (e.g., intermediate vehicles positioned between the first and second vehicles, roadside infrastructure positioned between the first and second vehicles, etc.) and relative movement between the first and second vehicles (e.g., the first and second vehicles moving farther apart, or moving with different headings) can also negatively impact performance/reliability for V2X communication. In general, decreasing performance/reliability for V2X communication will generally increase a likelihood for packet loss.

Accordingly, by increasing the number of SYN packets sent when the positional relationship between the first and second vehicles tends to increase the likelihood for packet loss (e.g., when the distance between vehicles is relatively large or the line of sight between the first and second vehicle is hindered), the second vehicle can increase a likelihood that at least one SYN packet is delivered successfully. By increasing the likelihood that at least one SYN packet is delivered successfully, the second vehicle can increase speed for the handshake between the first and second vehicle by e.g., avoiding a delay resulting from having to resend SYN packets (at a later time) due to packet loss. In other words, conventional technologies may wait a prescribed time before resending SYN packets after not receiving a SYN-ACK packet from the second vehicle. This can cause delays in a handshake process. By contrast, embodiments of the presently disclosed technology may proactively send multiple duplicate SYN packets simultaneously (or approximately simultaneously) to increase a likelihood that at least one SYN packet is received by the first vehicle in a shorter amount of time.

Relatedly, by decreasing the number of SYN packets sent when the positional relationship between the first and second vehicles tends to decrease a likelihood for packet loss, the second vehicle can reduce a number of SYN packets sent, which can conserve bandwidth and network resources.

Systems and methods of the presently disclosed technology will now be described in conjunction with the following FIGs.

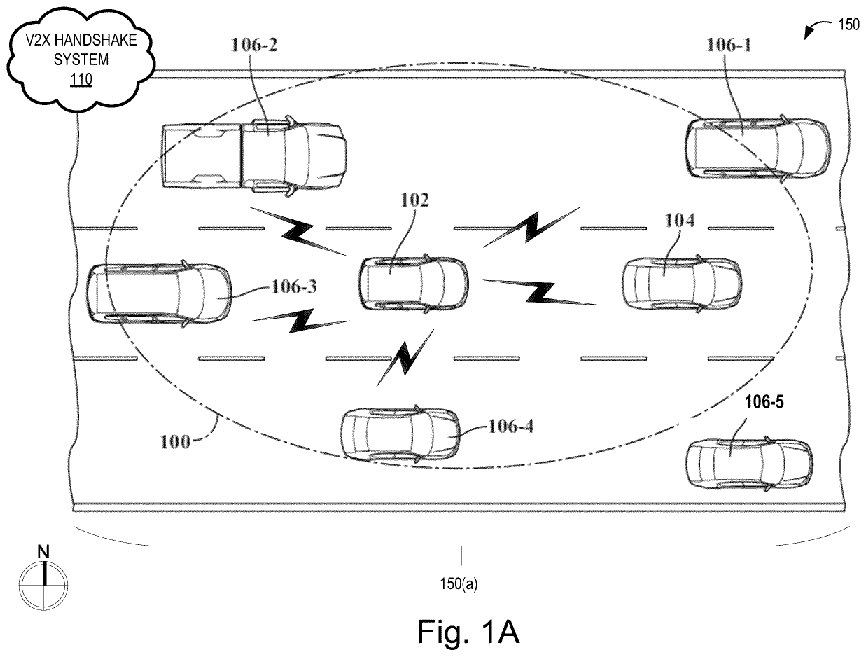

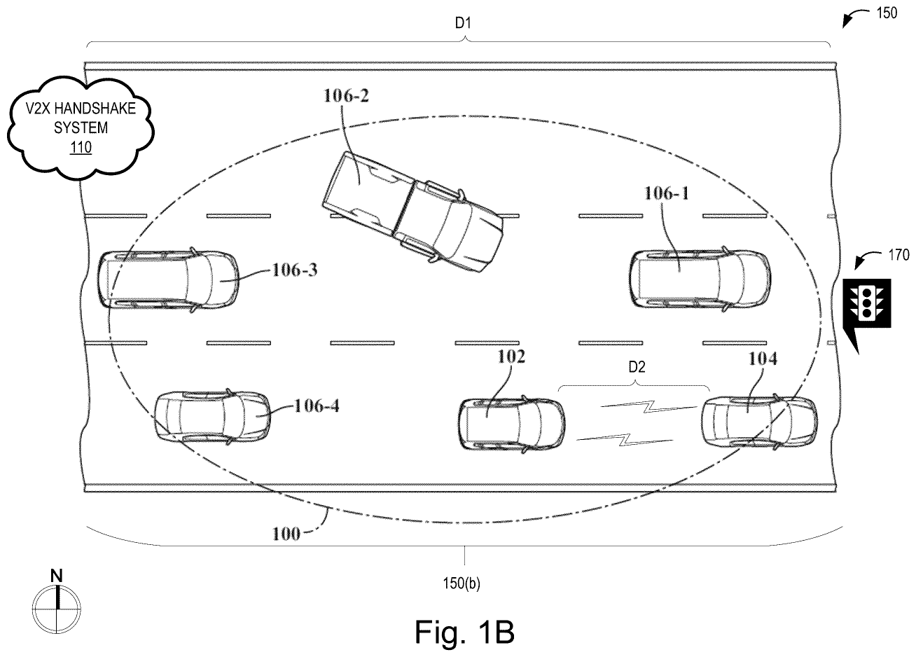

FIGS. 1A and 1B illustrate regions of a road segment 150 over which embodiments of the presently disclosed technology may be implemented.

Namely, FIG. 1A illustrates an example region 150(a) that vehicles traverse when approaching a traffic signal waiting zone 150(b) of road segment 150. FIG. 1B illustrates traffic signal waiting zone 150(b).

Traffic signal waiting zone 150(b) may comprise a region of road segment 150 proximate a traffic signal 170. More particularly, in certain implementations, traffic signal waiting zone 150(b) may comprise a region of road segment 150 bounded by traffic signal 170 on one side (e.g., the east side in FIG. 1B), and extending away (e.g., in the western direction in FIG. 1B) from traffic signal 170 by a determined distance (D1). Traffic signal 170 may comprise various types of traffic signals, such as a traffic light or a traffic sign (e.g., a stop sign, a yield sign, etc.). As described above, traffic signal waiting zone 150(b) may be a region of road segment 150 where nominal vehicle speed is stopped or is less than 5 MPH (e.g., while vehicles wait for traffic signal 170 to turn from red to green).

Region 150(a) may be a region of road segment 150 that vehicles traverse when approaching traffic signal waiting zone 150(b). In various implementations, a first boundary of region 150(a) (e.g., the western boundary of region 150(a) in FIG. 1A) may be a first determined distance from the closest boundary of traffic signal waiting zone 150(b) (e.g., the western boundary of traffic signal waiting zone 150(b). Similarly, a second boundary of region 150(a) (e.g., the eastern boundary of region 150(a) in FIG. 1A) may be a second determined distance from the closest boundary of traffic signal waiting zone 150(b) (e.g., the western boundary of traffic signal waiting zone 150(b)).

As depicted in FIG. 1A, vehicles 102, 104, 106-1, 106-2, 106-3, 106-4 and 106-5 may be traversing region 150(a) on their approach to traffic signal waiting zone 150(b). Here, vehicle 102 be a leader of a VMC 100 and vehicles 104, 106-1, 106-2, 106-3 and 106-4 may be other members of VMC 100. Vehicle 106-5 (depicted in FIG. 1A) may not be part of VMC 100.

As described above, vehicle 102 may be enabled to proactively send cryptographic cookies to other vehicles of VMC 100 (i.e., without having previously received requests for the cryptographic cookies from the vehicles of VMC 100). Transmission of the cryptographic cookies is depicted in FIG. 1A.

In certain implementations, vehicle 102 can use an encoder to generate a unique cryptographic cookie to send to each other member of VMC 100. Such an encoder may use filtering methods to generate these individually encoded cryptographic cookies. Such filtering methods may include a Boolean filter (e.g., AND/OR/XOR), a bloom filter, masking etc. Generating/encoding a unique cryptographic cookie to send to each other member of the VMC can help improve security for subsequent data transfers, reduce the efficacy of spoofing, etc.

In some implementations, vehicle 102 can send the cryptographic cookies via individual beacons when, for example, the other vehicles are within wireless coverage of vehicle 102. However, in other implementations (e.g., when the vehicles to receive the cryptographic cookies are not within wireless coverage of vehicle 102) vehicle 102 may transmit the cryptographic cookies to V2X handshake management system 110. In turn, V2X handshake management system 110 can transmit the cryptographic cookies to other vehicles. Here, V2X handshake management system 110 may be a cloud-based resource, an infrastructure-based resource, or any combination thereof.

As described above, by enabling vehicle 102 to proactively send cryptographic cookies to the other members of VMC 100, the presently disclosed handshake process can reduce a number of packets/communications required to complete a handshake as compared to conventional handshake processes. For example, unlike the TCP Fast Open handshake, the presently disclosed handshake process may not require a first/initial TCP 3-Way handshake to initially transmit a cryptographic cookie from vehicle 102 to vehicle 104. Instead, a single proactive packet/transmission may be used to initially transmit the cryptographic cookie from vehicle 102 to vehicle 104.

Moreover, in various implementations, vehicle 102 may intelligently determine which vehicles to proactively send the cryptographic cookie(s) to.

For example, as leader of VMC 100, vehicle 102 may predict/anticipate future V2X communication with other vehicles of VMC 100. Based on this prediction/anticipation, vehicle 102 may proactively send cryptographic cookies to the other vehicles of VMC 100 (i.e., vehicles 104, 106-1, 106-2, 106-3, 106-4). Relatedly, vehicle 102 may determine to refrain from sending cryptographic cookies to other vehicles on road segment 150 which are not part of VMC 100 (e.g., vehicle 106-5), or more generally, to vehicles that vehicle 102 does not predict/anticipate communicating with. Thus, vehicle 102 can: (1) reduce a number of packets/transmissions required to perform (anticipated) handshake processes within VMC 100; and (2) reduce a number cryptographic cookie transmissions sent to vehicles which are less likely to communicate with vehicle 102. In doing so, vehicle 102 can increase speed for communication and performance of VMC tasks, conserve bandwidth/network resources, etc.

In certain implementations, vehicle 102 can also intelligently determine when to proactively send cryptographic cookies. In some of such implementations, this may reduce a number of packets/transmissions exchanged at a traffic waiting zone (e.g., traffic signal waiting zone 150(b)). For example, when the vehicles of VMC 100 are traversing region 150(a), vehicle 102 may determine that the vehicles of VMC 100 are within a threshold proximity of traffic signal waiting zone 150(b) (e.g., within 100 ft). In response to this determination, vehicle 102 may proactively send the cryptographic cookies to the other vehicles of VMC 100 before the vehicles of VMC 100 reach traffic signal waiting zone 150(b). Accordingly, vehicle 102 can further reduce a number of packets/transmissions exchanged within traffic signal waiting zone 150(b). Relatedly, by waiting to send the cryptographic cookies until the vehicles of VMC 100 are within the threshold (e.g., imminent) proximity of traffic signal waiting zone 150(b), vehicle 102 can reduce a likelihood that the cryptographic cookies are not used by the other vehicles due to lack of V2X communication opportunity. Such lack of V2X communication opportunity may result another vehicle taking a divergent path from vehicle 102, or vehicle 102 and the other vehicle otherwise remaining in an unsuitable positional relationship for extended/lengthy V2X communication.

As depicted in FIG. 1B, vehicle 104 may engage in a handshake process with vehicle 102 while vehicles 102 and 104 wait within traffic signal waiting zone 150(b).

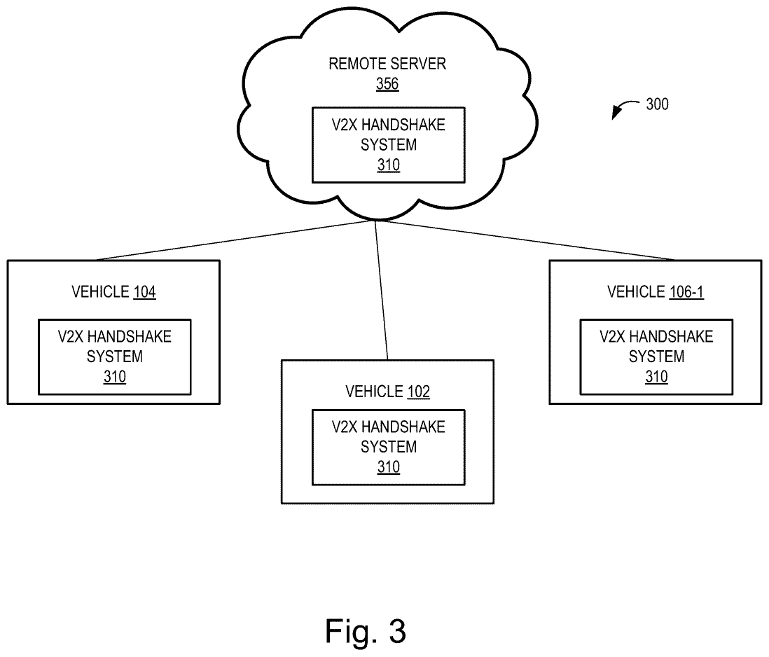

For example (and as described/depicted in more detail in conjunction with FIG. 3), vehicle 104 may receive and cache a cryptographic cookie sent be vehicle 102 (as depicted in FIG. 1A).

Accordingly, when vehicle 104 needs/wants to sent non-handshake-related data to vehicle 102 (e.g., data related to a VMC task), vehicle 104 can determine a number of SYN packets to send to vehicle 102 based on a positional relationship between vehicle 104 and vehicle 102. In various implementations, this may involve determining at least one of: (a) a distance (e.g., a distance (D2) depicted in FIG. 1B) between vehicle 104 and vehicle 102; (b) whether a line of sight between vehicle 104 and vehicle 102 is hindered (in the specific example of FIG. 1B, the line of sight between these two vehicles is unhindered); and (c) whether at least one of vehicle 104 and vehicle 102 are moving above a threshold speed (in the specific example of FIG. 1B, both vehicles may be stationary).

In certain implementations, vehicle 104 can determine the positional relationship between vehicle 104 and vehicle 102 using information contained in the cryptographic cookie it receives from vehicle 102. For example, the information contained in the cryptographic cookie may comprise at least one of: (a) a geographic location of vehicle 102; (b) a speed of the vehicle 102; (c) an estimated distance between vehicle 102 and vehicle 104; (d) a vehicle type of vehicle 102 that vehicle 104 can use to identify vehicle 102; etc. In various implementations, the information contained in the cryptographic cookie may also comprise information indicating one or more software applications used by the vehicle 102 and information related to VMC roles.

Upon determining the number of SYN packets to send to vehicle 102 based on the (determined) positional relationship between vehicle 104 and vehicle 102, vehicle 104 can send the determined number of SYN packets to vehicle 102. As alluded to above, the determined number of SYN packets may be sent to vehicle 102 simultaneously, or approximately simultaneously. A respective SYN packet may be a duplicate of the other SYN packets, and may comprise: (i) the cryptographic cookie received from vehicle 102, and (ii) the non-handshake-related data vehicle 104 wants/needs to send to vehicle 102 (e.g., data related to a VMC task).

As alluded to above, by enabling the vehicle 104 to tailor the number of SYN packets simultaneously (or approximately simultaneously) sent to vehicle 102 based on the positional relationship between vehicle 104 and vehicle 102, the presently disclosed handshake process can increase reliability and speed for V2X handshakes, while limiting excess/duplicative SYN packet transmissions.

Namely (and as alluded to above), performance/reliability for V2X communication can vary based on the positional relationship between vehicle 104 and vehicle 102. For example, performance/reliability for V2X communication generally decreases (e.g., with longer and more variable packet round-trip times (RTTs), higher incidence of packet loss, etc.) with increasing distance between vehicle 104 and vehicle 102. Physical obstructions between vehicle 104 and vehicle 102 (e.g., intermediate vehicles positioned between vehicle 104 and vehicle 102, roadside infrastructure positioned between vehicle 104 and vehicle 102, etc.) and relative movement between vehicle 104 and vehicle 102 (e.g., vehicle 104 and vehicle 102 moving farther apart, or moving with different headings) can also negatively impact performance/reliability for V2X communication. In general, decreasing performance/reliability for V2X communication will generally increase a likelihood for packet loss.

Accordingly, by increasing the number of SYN packets sent when the positional relationship between vehicle 104 and vehicle 102 tends to increase the likelihood for packet loss (e.g., when the distance between vehicles is relatively large or the line of sight between vehicles is hindered), vehicle 104 can increase a likelihood that at least one SYN packet is delivered successfully. By increasing the likelihood that at least one SYN packet is delivered successfully, vehicle 104 can increase speed for the handshake between vehicle 104 and vehicle 102 by e.g., avoiding a delay resulting from having to resend SYN packets (at a later time) due to packet loss. In other words, conventional technologies may wait a prescribed time before resending SYN packets after not receiving a SYN-ACK packet from vehicle 102. This can cause delays in a handshake process. By contrast, embodiments of the presently disclosed technology may proactively send multiple duplicate SYN packets simultaneously (or approximately simultaneously) to increase a likelihood that at least one SYN packet is received by vehicle 102 in a shorter amount of time.

Relatedly, by decreasing the number of SYN packets sent when the positional relationship between vehicle 104 and vehicle 102 tends to decrease a likelihood for packet loss, vehicle 104 can reduce a number of SYN packets sent, which can conserve bandwidth and network resources.

After vehicle 102 receives at least one SYN packet from vehicle 104, vehicle 102 can send vehicle 104 a SYN-ACK packet. Moreover, in certain implementations vehicle 104 can commence sending non-handshake-related data (e.g., additional data related to a VMC task) before it receives an ACK packet from vehicle 104. This can further expedite V2X communication and collaborative tasks involving vehicle 102 and vehicle 104 (e.g., VMC tasks).

It may be appreciated that in situations where vehicle 104 sends multiple/duplicate SYN packets, vehicle 102 may receive multiple/duplicate SYN packets. In these situations, vehicle 102 may discard additional SYN packets it receives from vehicle 104 after receiving the first SYN packet.

As alluded to above, in certain implementations, vehicle 102 can use an encoder to generate a unique cryptographic cookie to send to each other member of VMC 100. In such implementations, vehicle 102 can use a corresponding decoder to decode the cryptographic cookie contained in the SYN packet sent by vehicle 104. As alluded to above, the encoding/decoding of cryptographic cookies by vehicle 102 can help improve security for data transfers, reduce the efficacy of spoofing, etc.

After vehicle 104 receives the SYN-ACK packet from vehicle 102, vehicle 104 can send vehicle 102 an ACK packet - which when received by vehicle 102, may complete the presently disclosed handshake process.

The following paragraphs describe operation of VMC 100 (as an example of a VMC) more generally.

As described above, in certain implementations vehicles 102, 104, 106-1, 106-2, 106-3 and 106-4 may form a VMC. A VMC may refer to a group of vehicles that share resources (e.g., sensor resources, processing resources, memory resources, communication resources, etc.) to complete a task.

As an illustrative example, vehicle 102 (referred to hereafter as leader 102) may be a leader of VMC 100. Leader 102 may be a vehicle (or in some cases a piece of roadside infrastructure or more generally a remote server) that manages operation of VMC 100. For example, leader 102 may receive a request for a task to be completed, assign sub-tasks to particular VMC members, receive the output/results of completed sub-tasks, aggregate/combine the output/results of the completed sub-tasks into an output/results of the overall task, and promulgate the output/results of the overall task to VMC members. In certain implementations, leader 102 may also initiate formation of VMC 100. In the context of the present application, leader 102 can proactively send cryptographic cookies to other members of VMC 100 in anticipation of future V2X communication with these other VMC members.

As described above, through VMC 100, the vehicles of VMC 100 can share resources. Examples of shared resources may include sensor resources, processing resources, memory resources, communication resources, network bandwidth resources, etc. Examples of VMC sub-tasks that may be completed by a vehicle in VMC 100 may include executing software, executing calculations, sending/receiving messages or data, finding digital data stored by any member of VMC 100, instructing different members of VMC 100 to help with calculations, etc. Examples of information shared within VMC 100 may include image frames or video feeds from image sensors, image processing results, object detection results from proximity sensors, GPS coordinates, computation results from processing data from sensor sets, etc.

While particular reference is made to particular sub-tasks, various other sub-tasks may be completed by the members of VMC 100. When the various members complete these sub-tasks, leader 102 can provide a resultant/combined output of the sub-tasks to the members of VMC 100. That is, leader 102 (or in some cases a remote server) can aggregate data/output from the members to provide collaborative results relevant to a requested (overall) VMC task. Examples of tasks completed by VMC 100 may include dynamic map generation, cooperative path planning, distributed data storage, etc.

As described above, V2X networks can include V2V networks, V2I networks, V2N networks, or any combination thereof.

While particular reference is made to particular communication modalities of VMC 100, the communication network may include other connected paths across which multiple vehicles may communicate including other cellular or mobile communications networks. In other implementations, VMC 100 may comprise a network other than a V2X network. For example, certain V2X networks may not allow members to access and use the unused computing resources of the other endpoints of such networks. By comparison, VMC 100 may allow all members to access and use designated unused computing resources of the other members of VMC 100.

In various implementations, a respective member of VMC 100 can join VMC 100 via a handshake process with a coordinator of VMC 100 (e.g., leader 102 or a remote server). In certain implementations, the memory of a respective member can store member data. The member data may comprise digital data that describes one or more of the following: the identity of each of the members; what digital data, or bits of data, are stored by each member; what computing services are available from each member; what computing resources are available from each member and what quantity of these resources are available; and how to communicate with each member. In some implementations, the member data may also describe logical associations between vehicles.

VMC 100 may comprise various types of VMCs.

For example, VMC 100 may comprise a stationary VMC that is tied to a fixed geographical region (e.g., traffic signal waiting zone 150(b)). A vehicle can join a stationary VMC and contribute its resources upon entering the fixed geographical region as determined by a GPS sensor of the vehicle. The vehicle may leave the stationary VMC upon exiting from the fixed geographical region. When exiting from the fixed geographical region, the vehicle may hand over ongoing sub-tasks and data of the stationary VMC to other members.

As another example, VMC 100 may comprise a mobile VMC. A mobile VMC may be formed around a particular vehicle (e.g., leader 102) traversing segment 150. Vehicles within a threshold distance of the particular vehicle can join the mobile VMC via a handshake operation. As the particular vehicle moves, the geographic location of the mobile VMC may change with the movement of the particular vehicle and other members of the mobile VMC. A vehicle can join the mobile VMC when the vehicle is in an area covered by the mobile VMC. The vehicle can leave the mobile VMC when the vehicle exits the area covered by the mobile VMC. Where VMC 100 is a mobile VMC, leader 102 may advertise VMC 100, and vehicles within a threshold distance of leader 102 may join/participate in VMC 100.

As another example, VMC 100 may comprise one of consecutive interdependent VMCs formed along road segment 150. For example, it may be the case that one mobile VMC is not sufficient to carry out a VMC task, such as defining a model of the behavior of vehicles on a particular stretch of the roadway. Accordingly, as leader 102 travels along the roadway, it may pass through different VMCs, and the different VMCs can perform different sub-tasks such that the output of the different VMCs may be used to generate a larger output that spans multiple regions associated with the individual VMCs.

In yet another example, VMC 100 may comprise a remote VMC where an ego vehicle can be connected to other vehicles that are remote from the ego vehicle. In this example, the ego vehicle may be a remote leader and remotely control the collaboration of members. For example, an ego vehicle in one city may want to know the parking availability in a city spaced apart from the city where the ego vehicle is located. In this example, the ego vehicle could form a remote VMC with vehicles in the target city. The vehicles in the target city, using exterior sensors, could indicate parking availability to the ego vehicle.

While particular types of VMCs are described herein, different types of VMCs 100 may be implemented in accordance with the principles described herein.

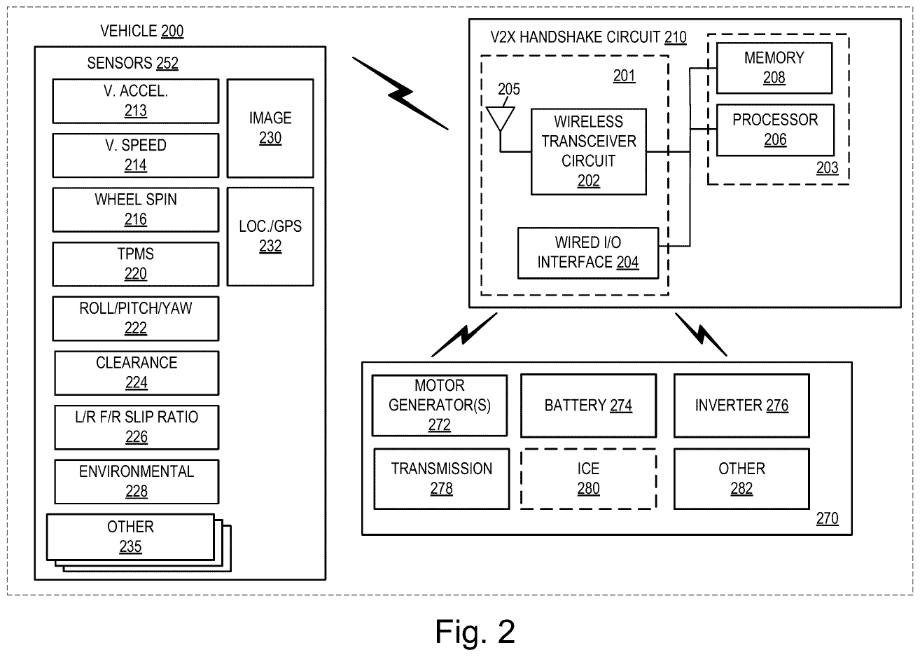

FIG. 2 illustrates an example vehicle 200, in accordance with various embodiments of the presently disclosed technology. Vehicle 200 may be an example of any of the vehicles depicted and described in conjunction with FIGS. 1A-1B.

As depicted, vehicle 200 comprises a V2X handshake circuit 210, sensors 252, and additional vehicle systems 270. Sensors 252 and additional vehicle systems 270 can communicate with V2X handshake circuit 210 via a wired or wireless communication interface. Although sensors 252 and additional vehicle systems 270 are depicted as communicating with V2X handshake circuit 210, they can also communicate with each other. V2X handshake circuit 210 can be implemented as an electronic control unit (ECU) or as part of an ECU. In other embodiments, V2X handshake circuit 210 can be implemented independently of an ECU.

In the specific example of FIG. 2, V2X handshake circuit 210 includes a communication circuit 201 and a decision circuit 203 (including a processor 206 and a memory 208). Components of V2X handshake circuit 210 are illustrated as communicating with each other via a data bus, although other interfaces can be included.

Processor 206 can include one or more general processing units (GPUs), central processing units (CPUs), microprocessors, or any other suitable processing system. Processor 206 may include a single core processor or multicore processors. Memory 208 can be made up of one or more modules of one or more different types of memory (e.g., flash, RAM, etc.) that may be used to store data related to VMC tasks, instructions and variables for processor 206, as well as any other suitable information.

Although the example of FIG. 2 is illustrated using processor and memory circuitry, in various embodiments decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up V2X handshake circuit 210.

Communication circuit 201 can utilize a wireless transceiver circuit 202 with an associated antenna 205 for wireless communication. Communication circuit 201 can also utilize a wired I/O interface 204 with an associated hardwired data port (not illustrated). As this example illustrates, communications with V2X handshake circuit 210 can include either or both wired and wireless communications. Wireless transceiver circuit 202 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment and to receive radio signals as well. These radio signals can include information of almost any sort that is sent or received by V2X handshake circuit 210 to/from other entities such as sensors 252, additional vehicle systems 270, other vehicles, connected roadside infrastructure, cloud computing entities, remote servers, etc.

Wired I/O interface 204 can include a transmitter and a receiver (not shown) for hardwired communications with other devices. For example, wired I/O interface 204 can provide a hardwired interface to other components, including sensors 252 and additional vehicle systems 270. Wired I/O interface 204 can communicate with other devices using Ethernet or any of a number of other wired communication protocols whether standardized, proprietary, open, point-to-point, networked or otherwise.

In certain implementations, decision circuit 203 and communication circuit 201 may be used for computation, memory, or communication tasks beyond V2X handshake control. In other implementations, vehicle 200 may comprise additional processing, memory, or communication resources (not depicted) devoted to these other tasks.

Sensors 252 can include, for example, vehicle acceleration sensors 213, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 1228 (e.g., to detect salinity or other environmental conditions), image sensor(s) 230, and location sensor(s) 232. Other sensors 235 can also be included as may be appropriate for a given implementation of vehicle 200. For example, other sensors 235 may include proximity sensors such as radar sensors, LiDAR sensors, and sonar sensors, etc.

In some embodiments, image sensor(s) 230 may comprise one or more cameras (e.g., monocular cameras, stereoscopic cameras, RGB cameras, infrared cameras, etc.) configured to obtain image data of an environment surrounding vehicle 200. Such image data (and sometimes in combination with proximity data obtained from proximity sensors) can be used to detect relative positions and behavior of other vehicles, proximity to intersections or corners of a road, etc.

In certain embodiments, location sensor(s) 232 may comprise a global navigation satellite sensor, a global position sensor, or other types of vehicle positioning sensors. Location sensor(s) 232 may be configured to generate location data for vehicle 200 and/or location data for landmarks in the environment surrounding vehicle 200 (e.g., intersections or corners of a road). The location data may comprise precise coordinates (e.g., latitude, longitude, and altitude) of vehicle 200's position or the position(s) of landmark(s) on the Earth's surface.

In some embodiments, one or more of sensors 252 may include their own processing capability to compute the results for additional information that can be provided to V2X handshake circuit 210. In other embodiments, one or more of sensors 252 may be data-gathering-only sensors that only provide raw data to V2X handshake circuit 210. In further embodiments, one or more hybrid sensors may be included that provide a combination of raw data and processed data to V2X handshake circuit 210. Sensors 252 may provide analog outputs, digital outputs, or a combination of both.

Additional vehicle systems 270 can include any of a number of different vehicle components or subsystems used to control or monitor various aspects of vehicle 200 and its performance. For example, additional vehicle systems 270 may include any one or combination of a motor generator system 272, a battery system 274, an inverter 276, and a transmission 278. In implementations where vehicle 200 is a hybrid vehicle, additional vehicle systems 270 may further comprise an internal combustion engine (ICE) 280. Additional vehicle systems 270 may also comprise other vehicle systems 282.

FIG. 3 depicts an example V2X handshake system 310, in accordance with various embodiments of the presently disclosed technology. Here, V2X handshake system 310 be an example of V2X handshake system 110 from FIGS. 1A-1B.

As depicted in FIG. 3, in some embodiments V2X handshake system 310 may be implemented across a remote server 356 and one or more vehicle traversing a road segment, such as vehicle 102, vehicle 104, and vehicle 106-3 from FIGS. 1A-1B. Such embodiments may be facilitated by a remote environment 300. In some embodiments, remove environment 300 may comprise a cloud-based environment. In other embodiments, remote environment 300 may comprise an edge-based environment. Such an edge-based environment can utilize various types of edge infrastructure, such as roadside/traffic infrastructure, cellular network infrastructure, etc.

In some embodiments, the vehicles across which V2X handshake system 310 is implemented may form a VMC.

Accordingly, as shown, V2X handshake system 310 may include separate instances within one or more entities of remote environment 300, such as remote server 356, vehicle 102, vehicle 104, and vehicle 106-3. In a further aspect, the entities that implement V2X handshake system 310 within remote environment 300 may vary beyond transportation-related devices and encompass roadside infrastructure elements. Thus, the set of entities that function in coordination with remote environment 300 may be varied.

In some embodiments, remote environment 300 itself may comprise a dynamic environment that comprises cloud members that migrate into and out of a geographic area.

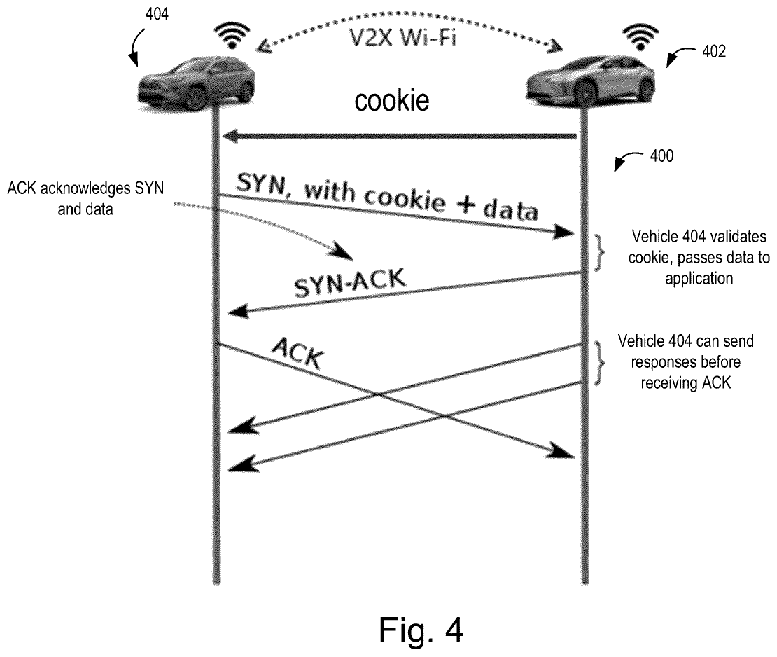

FIG. 4 illustrates an example handshake process 400 for V2X communication, in accordance with various embodiments of the presently disclosed technology.

As depicted, handshake process 400 may be performed by a vehicle 402 and a vehicle 404. Vehicles 402 and 404 may have the same/similar features as vehicle 200 described in conjunction with FIG. 2.

As depicted, handshake process 400 may first involve vehicle 402 proactively sending a cryptographic cookie to a vehicle 404 (i.e., without having previously received a request for the cryptographic cookie from vehicle 404). In various embodiments, vehicle 402 may proactively send the cryptographic cookie to vehicle 404 prior to completion (and in the illustrated example, prior to the initiation) of the handshake process. Vehicle 402 may perform this operation in the same/similar manner as described in conjunction with FIGS. 1A-1B.

Handshake process 400 may next involve vehicle 404 sending a handshake packet (a SYN packet in the illustrated example) with the cryptographic cookie and non-handshake-related data. As described above, in certain implementations vehicle 404 may determine a number of handshake packets (e.g., SYN packets) to send to vehicle 402 based on a positional relationship between vehicle 404 and vehicle 402. Vehicle 404 may perform such operation(s) in the same/similar manner as described in conjunction with FIGS. 1A-1B.

Upon receiving the SYN packet, vehicle 402 may validate the cryptographic cookie (e.g., using an encoder) and pass the non-handshake-related data to a software application running on vehicle 402 that the non-handshake-related data is intended for. After the cryptographic cookie is validated, vehicle 402 may send a SYN-ACK packet to vehicle 404.

As alluded to above, in situations where vehicle 402 receives multiple/duplicate SYN packets from vehicle 404, vehicle 402 can discard the additional/duplicate SYN packets received after the first SYN packet.

As depicted, vehicle 402 can also commence sending non-handshake-related data to vehicle 404 prior to receiving an ACK packet from vehicle 404.

As depicted, upon receiving the SYN-ACK packet from vehicle 402, vehicle 404 can send an ACK packet to vehicle 402, which when received by vehicle 402, completes handshake process 400.

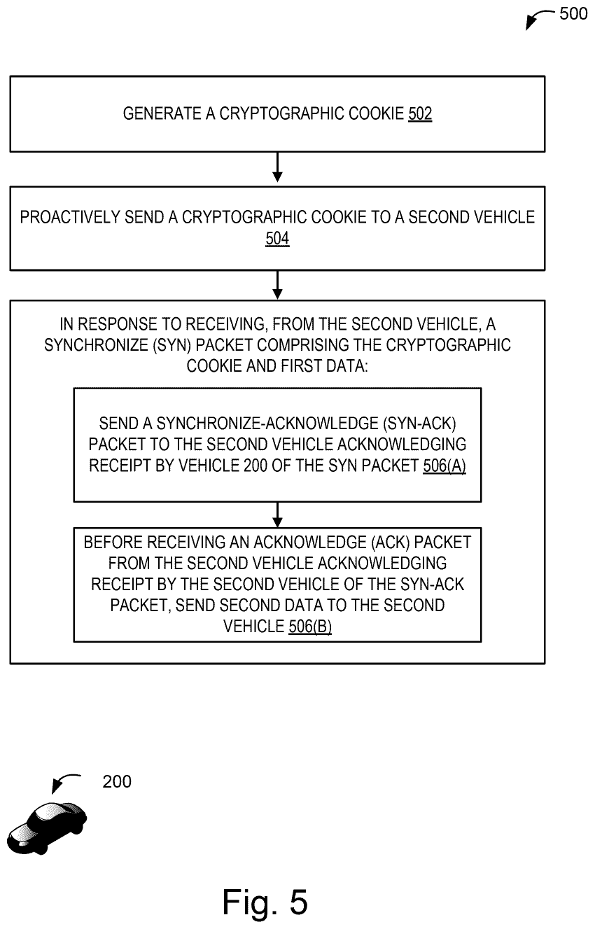

FIG. 5 illustrates an example handshake process 500 for V2X communication that may be performed by vehicle 200, in accordance with various embodiments of the presently disclosed technology.

As depicted, vehicle 200 can perform operation 502 to generate a cryptographic cookie. In certain implementations, this may involve generating the cryptographic cookie to include at least one of: (a) a geographic location of vehicle 200; (b) a speed of vehicle 200; (c) an estimated distance between vehicle 200 and other vehicles; and (d) information indicating whether a line of sight between vehicle 200 and other vehicles is hindered. As described above, a second vehicle that receives the generated cryptographic cookie may leverage this information to determine a positional relationship between vehicle 200 and the second vehicle. Based on this determined positional relationship, the second vehicle can determine a number of handshake packets (e.g., SYN, SYN-ACK or ACK packets) to send vehicle 200 when performing a handshake process of the presently disclosed technology.

In various implementations, generating the cryptographic cookie may also comprise generating the cryptographic cookie to further include at least one of: (e) information indicating one or more software applications used by vehicle 200; (f) a vehicle type for vehicle 200; and (g) information related to VMC roles. A second vehicle that receives the cryptographic cookie may use such information to determine, inter alia, types of data to send to vehicle 200.

As depicted, vehicle 200 can perform operation 504 to proactively send the cryptographic cookie to a second vehicle. As described above, proactively sending the cryptographic cookie to the second vehicle may comprise sending the cryptographic cookie to the second vehicle without having previously received a request for the cryptographic cookie from the second vehicle.

In certain implementations, vehicle 200 may proactively send the cryptographic cookie to the second vehicle in response to determining vehicle 200 and the second vehicle are within a threshold proximity to a traffic waiting zone. In some of such implementations, vehicle 200 may proactively send the cryptographic cookie to the second vehicle before vehicle 200 and the second vehicle reach the traffic waiting zone. In this way, vehicle 200 can reduce a number of V2X communications performed within the traffic waiting zone, thus conserving bandwidth and network resources within the traffic waiting zone. As described above, in some implementations the traffic waiting zone may comprise a region of a road segment traversed by vehicle 200 and the second vehicle, bounded at one end by a traffic signal, and extending away from the traffic signal towards the region of the road segment by a determined distance.

In various implementations, proactively sending the cryptographic cookie to the second vehicle may comprise at least one of: (a) sending the cryptographic cookie to the second vehicle via a beacon when the second vehicle is within wireless coverage range of vehicle 200; and (b) sending the cryptographic cookie to at least one of a cloud-based communication resource and an infrastructure-based communication resource, wherein the at least one of the cloud-based communication resource and the infrastructure-based communication resource transmits the cryptographic cookie to the second vehicle.

In response to receiving, from the second vehicle, a SYN packet comprising the cryptographic cookie and first data, vehicle 200 can perform operation 506(a) to send a SYN-ACK packet to the second vehicle acknowledging receipt of the SYN packet. Before receiving an ACK packet from the second vehicle acknowledging the second vehicle's receipt of the SYN-ACK packet, vehicle 200 can also perform operation 506(b) to send second data to the second vehicle.

Here the first and second data may comprise non-handshake related data, such as data related to a VMC task, or data related to a software application running on one or both of vehicle 200 and the second vehicle.

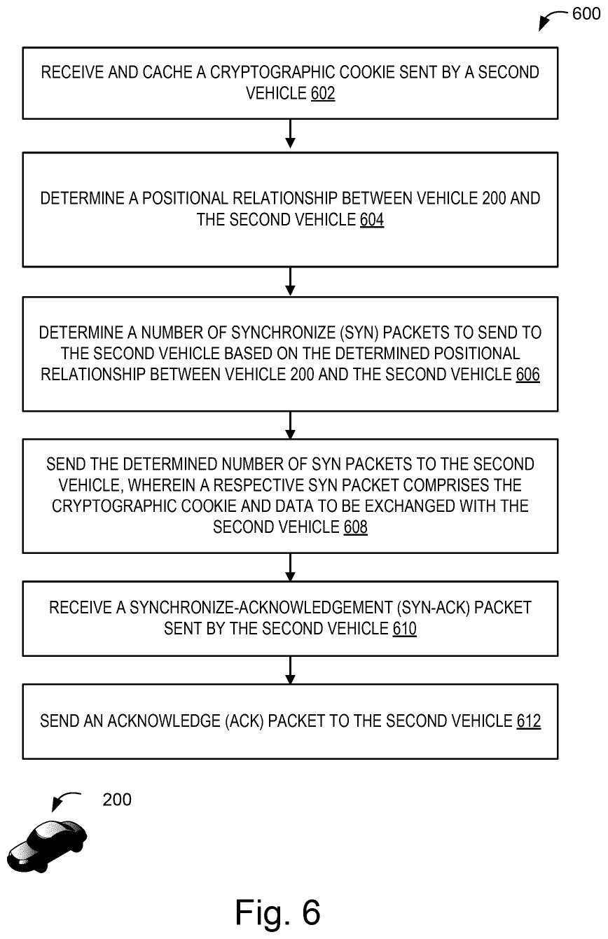

FIG. 6 illustrates an example handshake process 600 for V2X communication that may be performed by vehicle 200, in accordance with various embodiments of the presently disclosed technology.

As depicted, vehicle 200 can perform operation 602 to receive and cache a cryptographic cookie sent by a second vehicle. As described above, vehicle 200 may receive the cryptographic cookie without having previously requested the cryptographic cookie from the second vehicle.

Accordingly, when vehicle 200 needs/wants to send non-handshake related data to the second vehicle (e.g., as required to complete a VMC task), vehicle 200 can then perform operation 604 to determine a positional relationship between vehicle 200 and the second vehicle.

In various implementations, vehicle 200 can determine the positional relationship between vehicle 200 and the second vehicle by determining at least one of: (a) a distance between vehicle 200 and the second vehicle; (b) whether a line of sight between vehicle 200 and the second vehicle is hindered; and (c) whether at least one of vehicle 200 and the second vehicle are moving above a threshold speed.

In certain implementations, vehicle 200 can determine the positional relationship between vehicle 200 and the second vehicle using information contained in the cryptographic cookie. For example, the information contained in the cryptographic cookie may comprise at least one of: (a) a geographic location of the second vehicle; (b) a speed of the second vehicle; (c) an estimated distance between vehicle 200 and the second vehicle; and (d) whether a line of sight between vehicle 200 and the second vehicle is hindered. In some implementations, the information contained in the cryptographic cookie may further comprise: (e) information indicating one or more software applications used by the second vehicle; and (f) a vehicle type for the second vehicle. Vehicle 200 may use such information to determine, inter alia, types of data to send to the second vehicle.

As depicted, vehicle 200 can perform operation 606 to determine a number of SYN packets to send to the second vehicle based on the determined positional relationship between vehicle 200 and the second vehicle. Vehicle 200 may perform this operation in the same/similar manner described above.

Vehicle 200 can then perform operation 608 to send the determined number of SYN packets to the second vehicle. As alluded to above, a respective SYN packet may be a duplicate of the other SYN packets, and may comprise the cryptographic cookie along with non-handshake-related data to be exchanged with the second vehicle (e.g., data required to complete a VMC task).

As depicted, vehicle 200 can perform operation 610 to receive, from the second vehicle, a SYN-ACK packet acknowledging the second vehicle's receipt of at least one of the determined number of SYN packets. Relatedly, vehicle 200 can perform operation 612 to send an ACK packet to the second vehicle acknowledging vehicle 200's receipt of the SYN-ACK packet.

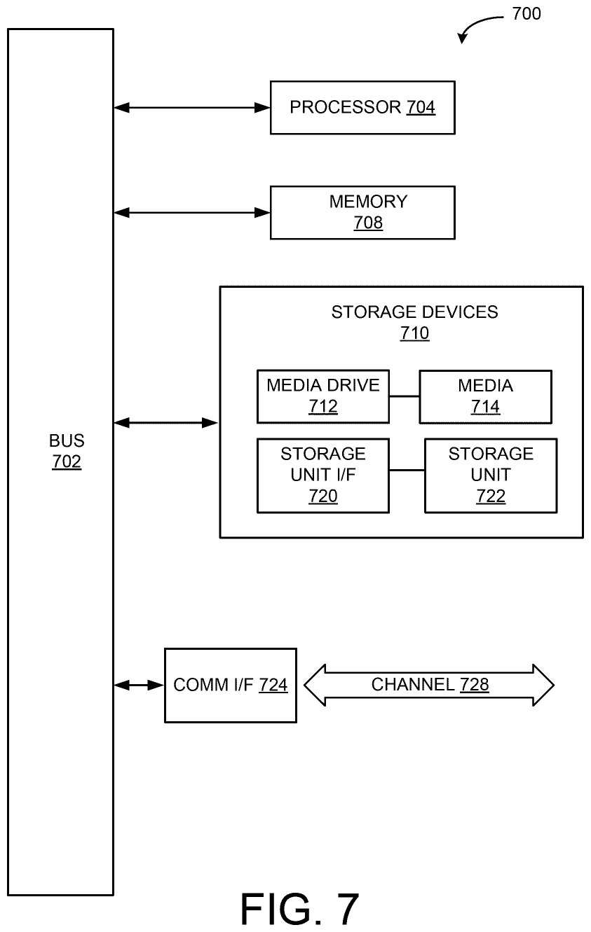

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up a user device, a user system, and a non-decrypting cloud service. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle comprising:
one or more processors; and
memory storing machine-readable instructions that, when executed by the one or more processors, cause the vehicle to:
determine a number of handshake packets to send to a second vehicle based on a positional relationship between the vehicle and the second vehicle; and
send the determined number of handshake packets to the second vehicle.

2. The vehicle of claim 1, wherein the handshake packets comprise Synchronize (SYN) packets and further wherein the memory stores further instructions, that when executed by the one or more processors, cause the vehicle to:
receive, from the second vehicle, a Synchronize-Acknowledgement (SYN-ACK) packet acknowledging the second vehicle's receipt of at least one of the determined number of handshake packets; and
send an Acknowledge (ACK) packet to the second vehicle acknowledging the vehicle's receipt of the SYN-ACK packet.

3. The vehicle of claim 1, wherein the memory stores further instructions, that when executed by the one or more processors, cause the vehicle to determine the positional relationship between the vehicle and the second vehicle by determining at least one of:
a distance between the vehicle and the second vehicle;
whether a line of sight between the vehicle and the second vehicle is hindered; and
whether at least one of the vehicle and the second vehicle are moving above a threshold speed.

4. The vehicle of claim 1, wherein the memory stores further instructions, that when executed by the one or more processors, cause the vehicle to receive and cache a cryptographic cookie sent by the second vehicle without having previously sent a request to the second vehicle for the cryptographic cookie.

5. The vehicle of claim 4, wherein the memory stores further instructions, that when executed by the one or more processors, cause the vehicle to determine the positional relationship between the vehicle and the second vehicle using information contained in the cryptographic cookie.

6. The vehicle of claim 5, wherein the information contained in the cryptographic cookie comprises at least one of:
a geographic location of the second vehicle;
a speed of the second vehicle;
an estimated distance between the vehicle and the second vehicle; and
whether a line of sight between the vehicle and the second vehicle is hindered.

7. The vehicle of claim 6, wherein the information contained in the cryptographic cookie further comprises at least one of:
information indicating one or more software applications used by the second vehicle; and
a vehicle type for the second vehicle.

8. The vehicle of claim 7, wherein data to be exchanged with the second vehicle is related to the one or more software applications used by the second vehicle.

9. The vehicle of claim 6, wherein the second vehicle is a vehicular micro-cloud (VMC) leader and the information contained in the cryptographic cookie further comprises information related to VMC roles.

10. The vehicle of claim 9, wherein data to be exchanged with the second vehicle is related to a task of the VMC.

11. The vehicle of claim 1, wherein the memory stores further instructions, that when executed by the one or more processors, cause the vehicle to receive and cache a cryptographic cookie from the second vehicle without previously sending a request for the cryptographic cookie to the second vehicle.

12. A vehicle comprising:
one or more processors; and
memory storing machine-readable instructions that, when executed by the one or more processors, cause the vehicle to:
proactively send a cryptographic cookie to a second vehicle, wherein proactively sending the cryptographic cookie to the second vehicle comprises sending the cryptographic cookie to the second vehicle without having previously received a request for the cryptographic cookie from the second vehicle; and
completing a handshake process with the second vehicle after proactively sending the cryptographic cookie to the second vehicle.

13. The vehicle of claim 12, wherein the memory stores further instructions, that when executed by the one or more processors, cause the vehicle to, in response to receiving, from the second vehicle, a Synchronize (SYN) packet comprising the cryptographic cookie and first data:
send a Synchronize-Acknowledge (SYN-ACK) packet to the second vehicle acknowledging receipt of the SYN packet, and
before receiving an Acknowledge (ACK) packet from the second vehicle acknowledging the second vehicle's receipt of the SYN-ACK packet, send second data to the second vehicle.

14. The vehicle of claim 12, wherein the memory stores further instructions, that when executed by the one or more processors, cause the vehicle to send to the second vehicle responses to data received from the second vehicle prior to completing the handshake process.

15. The vehicle of claim 12, wherein the memory stores further instructions, that when executed by the one or more processors, cause the vehicle to generate the cryptographic cookie to include at least one of:
a geographic location of the vehicle;
a speed of the vehicle;
an estimated distance between the vehicle and the second vehicle; and
information indicating whether a line of sight between the vehicle and the second vehicle is hindered.

16. The vehicle of claim 15, wherein generating the cryptographic cookie comprises generating the cryptographic cookie to further include at least one of:
information indicating one or more software applications used by the vehicle; and
a vehicle type for the vehicle.

17. The vehicle of claim 16, wherein the first data and the second data are related to the one or more software applications used by the vehicle.

18. The vehicle of claim 16, wherein the vehicle is a vehicular micro-cloud (VMC) leader and generating the cryptographic cookie comprises generating the cryptographic cookie to further include information related to VMC roles.

19. The vehicle of claim 18, wherein the first data and the second data are related to a task of the VMC.

20. The vehicle of claim 12, wherein proactively sending the cryptographic cookie to the second vehicle comprises at least one of:
sending the cryptographic cookie to the second vehicle via a beacon when the second vehicle is within wireless coverage range of the vehicle; and
sending the cryptographic cookie to at least one of a cloud-based communication resource and an infrastructure-based communication resource, wherein the at least one of the cloud-based communication resource and the infrastructure-based communication resource transmits the cryptographic cookie to the second vehicle.

21. The vehicle of claim 12, wherein the memory stores further instructions, that when executed by the one or more processors, cause the vehicle to:
determine the vehicle and the second vehicle are within a threshold proximity to a traffic waiting zone;
wherein proactively sending the cryptographic cookie to the second vehicle comprises:
in response to determining the vehicle and the second vehicle are within the threshold proximity to the traffic waiting zone, proactively sending the cryptographic cookie to the second vehicle before the vehicle and the second vehicle reach the traffic waiting zone.

22. The vehicle of claim 21, wherein the traffic waiting zone comprises a region of a road segment traversed by the vehicle and the second vehicle, bounded at one end by a traffic signal, and extending away from the traffic signal towards the region of the road segment by a determined distance.

23. A method comprising:
receiving and caching, by a first vehicle, a cryptographic cookie sent by a second vehicle;
determining, by the first vehicle, a number of Synchronize (SYN) packets to send to the second vehicle based on a positional relationship between the first vehicle and the second vehicle; and
sending, by the first vehicle, the determined number of SYN packets to the second vehicle, wherein a respective SYN packet comprises the cryptographic cookie and data to be exchanged with the second vehicle.
